(19) United States
(12) Patent Application Publication
(10) Pub. No.: US 2024/0377111 A1
(43) Pub. Date: Nov. 14, 2024

(54) POWER-SCALABLE CRYOGENIC OPTICAL REFRIGERATOR

(71) Applicant: UNM RAINFOREST INNOVATIONS, Albuquerque, NM (US)

(72) Inventors: Mansoor SHEIK-BAHAE, Albuquerque, NM (US); Alexander Robert ALBRECHT, Albuquerque, NM (US)

(73) Assignee: UNM RAINFOREST INNOVATIONS, Albuquerque, NM (US)

(21) Appl. No.: 18/347,240

(22) Filed: Jul. 5, 2023

Related U.S. Application Data
(60) Provisional application No. 63/389,125, filed on Jul. 14, 2022.

(51) Int. Cl. F25B 23/00; G02B 1/02

(52) U.S. Cl. CPC F25B 23/00; G02B 1/02; G02B 2207/113

(57) ABSTRACT

A pumping scheme and cryo-cooler design for cryogenic optical refrigeration is described, which is power scalable, alignment free, and optimized for the use of low brightness, highly divergent diode laser sources. Such highly divergent pump beams are employed in order to drastically suppress potential nonlinearities (such as absorption saturation, self-focusing, and stimulation emission) that have thus far prevented power scaling in such devices. This promises lower cost, simpler, more compact, more energy efficient, and more reliable vibration free optical (cryo-) coolers. This cooler design can also be implemented using high-brightness pumps (such as fiber lasers) by adjusting the divergence of the beam.

### CROSS-REFERENCE TO RELATED APPLICATIONS

This application claims priority to U.S. Provisional Application Ser. No. 63/389,125 filed on Jul. 14, 2022, which is hereby incorporated by reference in its entirety.

### GOVERNMENT RIGHTS

This disclosure was made with Government support under Contract No. FA9550-16-1-0362 awarded by the Air Force Office of Scientific Research (AFOSR). The Government has certain rights in the invention.

### TECHNICAL FIELD

Embodiments described herein relate generally to optical refrigerator, particularly to a power scalable cryogenic optical refrigerator.

### BACKGROUND

Optical Refrigeration, also referred to as laser cooling of solids, relies on anti-Stokes fluorescence, typically from rare-earth ions to remove heat from a glass or crystalline host [1], which we will from now on refer to as “crystal”. UNM has been the leading institution in the world in this research. UNM scientists have cooled a ytterbium-doped yttrium lithium fluoride (Yb:YLF) crystal to temperatures as low as 87 K starting from room temperature [2]. This paved the way for the demonstration of the world's first all-solid-state cryocooler, cooling an HgCdTe sensor with a Yb:YLF crystal to 134 K in 2018 [3]. The most recent experiments showed improved cooling of a payload below 125 K [4].

Due to the sharp drop of resonant absorption in the anti-Stokes regime, cryogenic optical refrigeration requires multi-pass pumping schemes to ensure sufficiently high pump absorption at cryogenic temperatures. A pump laser circulator or cavity, such as an astigmatic Herriott cell is typically implemented to optimize the pump laser coupling [5]. This consists of a 2 (or more) mirror multi-pass cavity (FIG. 1A) that surrounds the cooling crystal and allows up to hundreds of pump passes through the cooling crystal. This scheme relies on a good beam quality laser (typically fiber laser) for precise alignment of the launching angle into the Herriott cell, as well as the alignment of the two external mirrors to each other to achieve a sufficient number of passes.

For a monolithic multi-pass cavity, reflective coatings can be deposited directly onto the cooling material (FIG. 1i). We have previously disclosed [6], that an ideal coating should have either narrow-band high reflectivity at the pump wavelength, or a drop in reflectivity for wavelengths longer than the pump (FIG. 1C) to suppress amplified spontaneous emission or lasing, which would result in lower cooling efficiency or heating.

In a practical optical refrigerator, as shown in FIG. 2, a cold finger or load to be cooled is attached to the cooling crystal via a heat link. This heat link is used to remove heat from the cold finger while preventing the crystal's fluorescence from reaching the cold finger or load, where it would generate unwanted heat. Possible heat link geometries and appropriate material choices are described in the recently awarded patent [7].

### SUMMARY

According to examples of the present disclosure, a laser cooling system is disclosed that comprises a multi-pass optical cavity; a first mirrored crystal; a first mirror positioned at a first end of the first mirrored crystal; a second mirror positioned at a second end of the first mirrored crystal; and a laser source that produces a divergent laser beam or that produces a laser beam that is made divergent using one or more optical elements that is coupled into the first mirrored crystal.

The laser cooling system can include one or more of the following features. The first mirror or the second mirror comprises a spectrally selective coating to suppress amplified spontaneous emission (ASE) and parasitic lasing to avoid undesired heat generation in a material being cooled in the multi-pass optical cavity and the spectrally selective coating is deposited onto the mirrored crystal such that a stable laser resonator is not formed. The one or more optical elements can comprise a lens, such as a positive converging lens that focuses the beam in a tight spot after which it diverges or a negative diverging lens, or an aberrator plate. At least one facet of the first mirrored crystal is polished at an angle or at a specific curvature. At least one facet of the first mirrored crystal is uncoated or coated with an anti-reflection coating. The first mirror or the second mirror comprises a flat, curved, or angled reflective surface and is arranged externally and in close proximity to the first mirrored crystal. The laser cooling system further comprises a spectrally selective filter element that is arranged in the multi-pass cavity. The laser source comprises a laser diode. The divergent laser beam is focused to a point or a line on the first surface of mirrored crystal using one or more lenses or mirrors. The divergent laser beam is coupled into the first mirrored crystal by an optical fiber. The laser cooling system further comprises a heat link that is coupled to the multi-pass cavity at one end and coupled to a cold finger at another end. The first mirror comprises a hole to allow a pump laser beam to enter. The first mirrored crystal comprises a rare-earth-doped crystal. The spectrally selective coating introduces a loss at wavelengths longer than a pump laser and prevents buildup of ASE and eliminates laser oscillation at longer wavelengths by ensuring a net optical gain that never exceeds losses in each roundtrip in the multi-pass optical cavity. The first mirror, the second mirror, or both the first mirror and the second mirror have low reflectivity for longer wavelengths of a fluorescence spectrum. The spectrally selective coating comprises a dielectric coating or a distributed Bragg reflector that is deposited on a surface of the first mirror or the second mirror or attached to the mirrored crystal. The high reflectivity is greater than 99% at about 1020 nm for a Yb-based cooling material. The spectrally selective coating provides a drop-off of reflectivity for wavelengths longer than a pump wavelength. The drop-off of reflectivity is about less than 97% at 1030 nm for and about less than 90% at 1040 nm for a Yb-based cooling material. The spectrally selective coating provides lower reflectivity at shorter wavelengths than a pump wavelength. The laser cooling system further comprises one or more additional mirrored crystals. The laser cooling system further comprises a lens arranged proximate to the laser source to produce the divergent laser beam.

According to examples of the present disclosure, a method for laser cooling is disclosed The method comprises directing a divergent laser beam into a multi-pass optical cavity, the multi-pass cavity comprising a first mirror positioned at a first end of the multi-pass optical cavity and a second mirror positioned at a second end of the multi-pass optical cavity, wherein the first mirror or the second mirror comprises a spectrally selective coating to suppress amplified spontaneous emission (ASE) and parasitic lasing to avoid undesired heat generation in a material being cooled in the multi-pass optical cavity and the spectrally selective coating is deposited onto the crystal such that a stable laser resonator is not formed; and optically cooling the material by repeated passes of the pump laser beam.

The method for laser cooling can include one or more of the following features. The first mirror comprises a hole to allow an input laser beam to enter. The material being cooled comprises a rare-earth-doped crystal. The spectrally selective coating introduces a loss at wavelengths longer than a pump laser and prevents buildup of ASE while eliminating laser oscillation at longer wavelengths by ensuring a net optical gain that never exceeds losses in each roundtrip in the multi-pass optical cavity. The first mirror, the second mirror, or both the first mirror and the second mirror have low reflectivity for longer wavelengths of a fluorescence spectrum. The at least one facet of the material is polished at an angle or at a specific curvature. The at least one facet of the material is uncoated or coated with an anti-reflection coating. The first mirror or the second mirror comprises a flat, curved, or angled reflective surface and is arranged externally and in close proximity to the first mirrored crystal. The divergent laser source comprises a laser diode.

According to examples of the present disclosure, a laser cooling system is disclosed. The laser cooling system comprises a multi-pass optical cavity; a first crystal; a first mirror positioned at a first end of the first crystal; a second mirror positioned at a second end of the first crystal; a second crystal; a third mirror positioned at a first end of the second crystal; a fourth mirror positioned at a second end of the second crystal; a heat link that couples the first crystal and the second crystal; a first laser source that produces a first divergent laser beam that is coupled into the first crystal; and a second laser source that produces a second divergent laser beam that is coupled into the second crystal, wherein the first mirror or the second mirror and the third mirror or the fourth mirror comprise a spectrally selective coating to suppress amplified spontaneous emission (ASE) and parasitic lasing to avoid undesired heat generation in a material being cooled in the multi-pass optical cavity and the spectrally selective coating is deposited onto the crystal.

The laser cooling system can include one or more of the following features. The heat link comprises a MgF₂ heat link with a textured surface to reduce total internal reflection inside the heat link. The at least one facet of the first crystal or the second crystal, or both is polished at an angle or at a specific curvature. The at least one facet of the first crystal or the second crystal, or both is uncoated or coated with an anti-reflection coating. The first mirror or the second mirror comprises a flat, curved, or angled reflective surface and is arranged externally and in close proximity to the first crystal. The laser cooling system further comprises a spectrally selective filter element that is arranged in the multi-pass cavity. The first laser source or the second laser source comprise a laser diode. The first divergent laser beam is focused tightly to a point or a line on a first crystal surface to create a large divergence using one or more lenses or mirrors. The first divergent laser beam is coupled into the first mirrored crystal by an optical fiber. The first crystal, the second crystal, or both comprise a rare-earth-doped crystal. The spectrally selective coating introduces a loss at wavelengths longer than a pump laser and prevents buildup of ASE and eliminates laser oscillation at longer wavelengths by ensuring a net optical gain that never exceeds losses in each roundtrip in the multi-pass optical cavity. The first mirror, the second mirror, or both the first mirror and the second mirror have low reflectivity for longer wavelengths of a fluorescence spectrum. The spectrally selective coating comprises a dielectric coating or a distributed Bragg reflector that is deposited on a surface of the first mirror, the second mirror, the third mirror, or the fourth mirror. The reflectivity is greater than 99% at about 1020 nm for a Yb-based cooling material. The spectrally selective coating provides a drop-off of reflectivity for wavelengths longer than a pump wavelength. The drop-off of reflectivity is about less than 97% at 1030 nm for and about less than 90% at 1040 nm for a Yb-based cooling material. The spectrally selective coating provides lower reflectivity at shorter wavelengths than a pump wavelength.

### BRIEF DESCRIPTION OF THE DRAWINGS

The accompanying drawings, which are incorporated in and constitute a part of this specification, illustrate embodiments of the present teachings and together with the description, serve to explain the principles of the disclosure.

FIG. 1A shows a conventional multi-pass pumping (Herriott cell) using two external mirrors, FIG. 1B shows a conventional multi-pass pumping with mirrors deposited onto cooling crystal facets, FIG. 1C shows a spectrally selective coating for at least one of the cavity mirrors, for suppression of ASE and parasitic lasing.

FIG. 2 shows a schematic diagram of another conventional optical refrigeration system.

FIG. 3A shows a schematic diagram of laser cooling crystal with deposited mirror coatings showing incident laser light and an example light ray being reflected by the mirrors and total internal reflection inside the crystal according to examples of the present disclosure.

FIG. 3B shows a schematic diagram of laser cooling crystal with one facet could be polished at an angle according to examples of the present disclosure.

FIG. 3C shows a schematic diagram of laser cooling crystal with a concave curvature according to examples of the present disclosure.

FIG. 3D shows a schematic diagram of laser cooling crystal with an external mirror according to examples of the present disclosure.

FIG. 4A, FIG. 4B, FIG. 4C, and FIG. 4D show schematic diagram of laser coupling schemes according to examples of the present disclosure, where FIG. 4A shows an example where by placing a laser diode in close proximity of an open aperture in the mirror coating of one facet of the crystal, FIG. 4B shows an example where by focusing the light of a laser diode onto the aperture, FIG. 4C shows an example where by contacting an optical fiber to the crystal, and FIG. 4D shows an example where by focusing the light from an optical fiber onto the aperture. For simplicity, only the first pass of the laser beam through the crystal is shown. It would be reflected multiple times by the mirror coating, or by total internal reflection at the crystal-air interfaces.

FIG. 5A and FIG. 5B show schematic diagrams of laser coupling schemes according to examples of the present disclosure that are arranged to avoid laser damage to crystal surface for high-brightness lasers by focusing the laser in front of the facet in FIG. 5A and using an aberrator plate to distort wavefront, resulting in larger focal spot, in FIG. 5B.

FIG. 6A, FIG. 6B, FIG. 6C, FIG. 6D show examples of heat link geometries according to examples of the present disclosure, wherein FIG. 6A shows an angled link attached to mirror-coated crystal facet, FIG. 6B shows a straight link attached to facet, FIG. 6C shows a tapered link attached to side of crystal using additional mirror coating applied to the crystal, and FIG. 6D shows a heat link with multiple cooling crystals using an unpolarized laser.

FIG. 7A shows a plot of cooling power density versus temperature for different pump powers below and above saturation according to examples of the present disclosure.

FIG. 7B shows plots of cooling efficiency versus sample size for (top) rectangular and (bottom) square cooling samples according to examples of the present disclosure.

FIG. 8A and FIG. 8B show examples of cryocooler designs according to examples the present disclosure, where FIG. 8A uses one and FIG. 8B uses two cooling crystals, a heat link surrounded by absorptive, low emissivity coating applied to a heatsink; a baffle is used for additional light shielding of the cold finger. FIG. 8B shows an example of a Yb:YLF-based cooler with MgF₂ heat link with textured surface to reduce total internal reflection inside the link. Also shown is the crystal axis c alignment for coefficient of thermal expansion match between YLF and MgF₂.

FIG. 9 shows a plot of Yb:YLF crystal temperature, determined by differential luminescence thermometry, versus time in a cooling experiment performed using 40 W laser power at 1020 nm according to examples of the present disclosure.

### DETAILED DESCRIPTION

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g., −1, −2, −3, −10, −20, −30, etc.

The following embodiments are described for illustrative purposes only with reference to the figures. Those of skill in the art will appreciate that the following description is exemplary in nature, and that various modifications to the parameters set forth herein could be made without departing from the scope of the present embodiments. It is intended that the specification and examples be considered as examples only. The various embodiments are not necessarily mutually exclusive, as some embodiments can be combined with one or more other embodiments to form new embodiments. It will be understood that the structures depicted in the figures may include additional features not depicted for simplicity, while depicted structures may be removed or modified.

Generally speaking, examples of the present disclosure provide for a pumping scheme and cryo-cooler design for cryogenic optical refrigeration is described, which is power scalable, alignment free, and optimized for the use of low brightness, highly divergent diode laser sources. Such highly divergent pump beams are employed in order to drastically suppress potential nonlinearities (such as absorption saturation, self-focusing, and stimulation emission) that have thus far prevented power scaling in such devices. This promises lower cost, simpler, more compact, more energy efficient, and more reliable vibration free optical (cryo-) coolers. This cooler design can also be implemented using high-brightness pumps (such as fiber lasers) by adjusting the divergence of the beam. As discussed further below, a cooling crystal is a crystal that exhibits optical refrigeration, where the pump laser light is absorbed by the crystal and the fluorescence light emitted by the crystal has, on average, higher energy than the pump light, thereby reducing the temperature of the crystal. Also, as discussed further below, a multi-pass cell is formed by at least two mirror coatings (or spectrally selective coatings). The coatings can be deposited on opposite facets of the crystal, or can be external, in close proximity of the crystal, or a combination thereof.

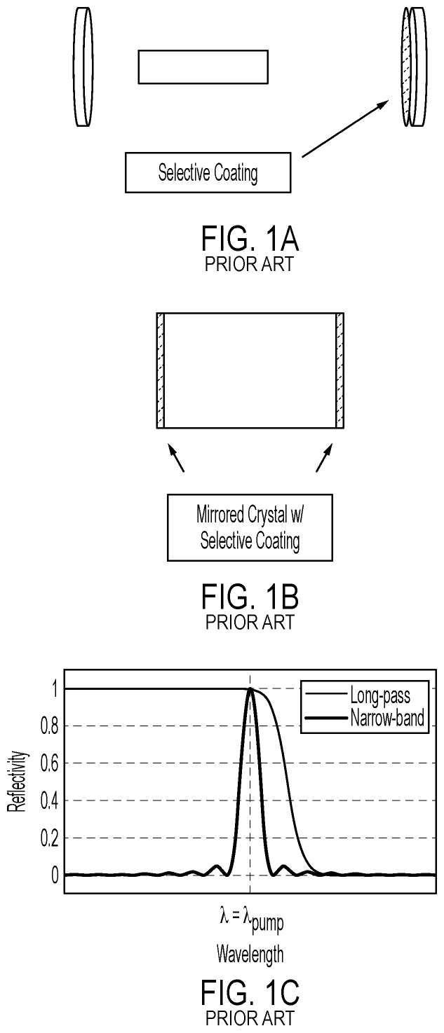

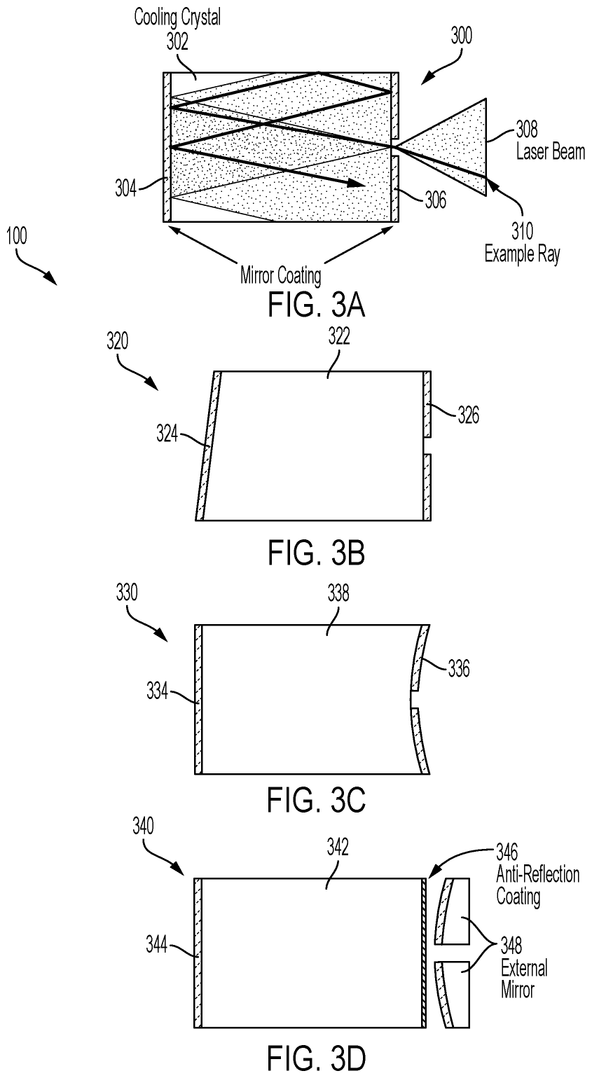

FIG. 3A shows a schematic diagram 300 of laser cooling crystal with deposited mirror coatings showing incident laser light and an example light ray being reflected by the mirrors and total internal reflection inside the crystal according to examples of the present disclosure. According to examples of the present disclosure as shown in FIG. 3A, a mirrored crystal with spectrally selective coating is used, as shown in FIG. 1B, in combination with a laser diode or other highly divergent laser source. Typical high-power laser diodes have low beam quality, divergent, asymmetrical laser beams that don't lend themselves to the use in external Herriott cells commonly used in optical refrigeration prototypes. By using a mirrored crystal, we rely on monolithically integrated, alignment free mirrors coated onto the end facets of the crystal in combination with total internal reflection on the uncoated crystal-air interfaces to allow for multiple passes through the cooling crystal, as shown in FIG. 3A, to maximize the laser absorption.

As shown in FIG. 3A, cooling crystal 302 comprises first mirror coating 304 formed on a first end, i.e., facet, of cooling crystal 302 and second mirror coating 306 formed on a second end, i.e., facet, of cooling crystal 302. Laser beam 308, with example ray 310, is directed through second mirror coating 306, such as through an aperture in second mirror coating 306 to be reflected back into cooling crystal 302 by first mirror coating 304. In some examples, one or both mirror coatings may be a long-pass or narrow-band mirror coating. One manner to make a narrow-band mirror is to allow one mirror coating to be a long-pass mirror and the other to be a short-pass mirror, effectively acting like a narrow-band mirror after one round trip. The long-pass mirror transmits wavelengths longer than the pump laser wavelength and the short-pass mirror transmits wavelength shorter than the pump laser wavelength.

As mentioned in [6], at least one of the mirror coatings on the crystal should be spectrally selective, to reduce amplified spontaneous emission and parasitic lasing. To further reduce the likelihood of the cooling crystal lasing, the geometry of the cooling crystal can be modified, so the coatings deposited onto the crystal do not form a stable laser resonator. FIG. 3B shows a schematic diagram of laser cooling crystal with one facet could be polished at an angle according to examples of the present disclosure. FIG. 3C shows a schematic diagram of laser cooling crystal with a concave curvature according to examples of the present disclosure. FIG. 3D shows a schematic diagram of laser cooling crystal with an external mirror according to examples of the present disclosure. This could be done by polishing at least one facet of the crystal at an angle, as shown in FIG. 3B or with a curvature, as shown in FIG. 3C.

FIG. 3B shows another schematic diagram 320 of laser cooling crystal according to examples of the present disclosure. As shown in FIG. 3B, cooling crystal 322, which can be the same as cooling crystal 302, comprises first angled mirror coating 324 formed on a first end, i.e., facet, of cooling crystal 322 and second mirror coating 326, which can be the same as second mirror coating 306, formed on a second end, i.e., facet, of cooling crystal 322.

FIG. 3C shows yet another schematic diagram 330 of laser cooling crystal according to examples of the present disclosure. As shown in FIG. 3C, cooling crystal 338, which can be the same as cooling crystal 302, comprises first angled mirror coating 334, which can be the same as first mirror coating 304, formed on a first end of cooling crystal 338 and second curved mirror coating 336 formed on a second end of cooling crystal 338.

Alternatively, one facet of the crystal could remain uncoated, or anti-reflection coated, and the (flat, curved, or angled) mirror could be placed externally, in close proximity to the crystal, as shown in FIG. 3D. In this case, a separate spectrally selective filter element may be inserted inside the cavity, instead of a spectrally selective coating on the crystal or mirror. Since the distance between the crystal and external mirror can be made sufficiently small, a precise alignment of the mirror is not necessary. FIG. 3D shows still another schematic diagram 340 of laser cooling crystal according to examples of the present disclosure. As shown in FIG. 3D, cooling crystal 342, which can be the same as cooling crystal 302, comprises first mirror coating 344, which can be the same as first mirror coating 304, formed on a first end of cooling crystal 342. The second end of cooling crystal 342 comprises an anti-reflection coating 346. External mirror 348, which can be flat, curved, or angled, is arranged on the side of the second end of cooling crystal 342.

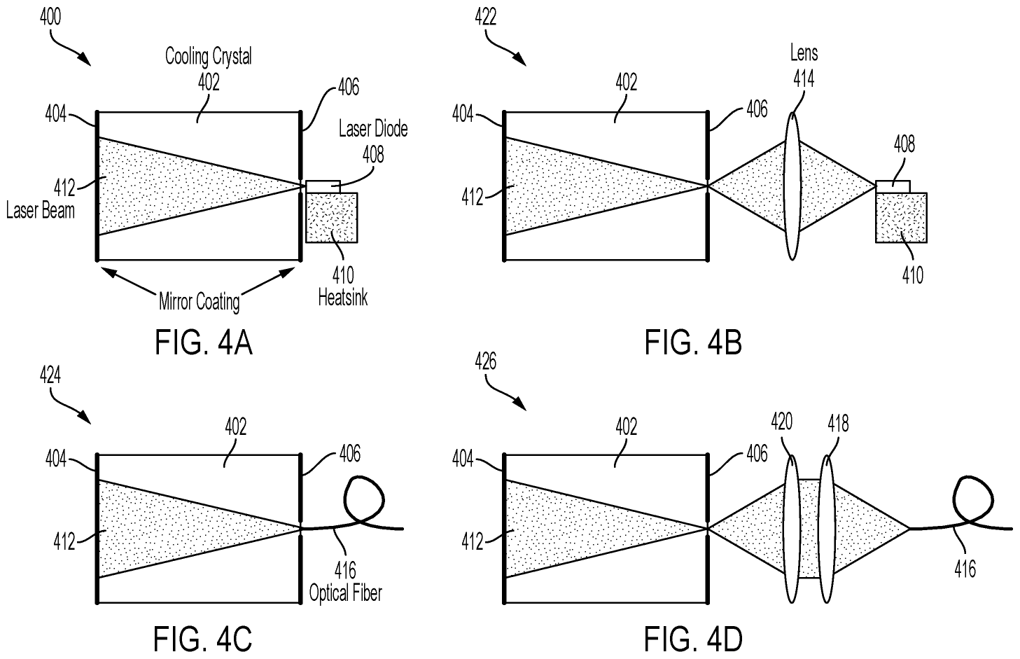

Several examples of coupling the laser light into the cooling crystal are shown in FIG. 4A, FIG. 4B, FIG. 4C, and FIG. 4D. A laser diode could be brought into close proximity of the cooling crystal, allowing the diverging light to enter through an aperture in the mirror coating, as shown in FIG. 4A. The light from the laser diode could be focused to a point or line on the crystal, using lenses (spherical, cylindrical, . . . ) or mirrors, as shown in FIG. 4B. A fiber-coupled laser or laser diode could be utilized by bringing the output optical fiber into contact or close proximity of the crystal, as shown in FIG. 4C, or by focusing it onto a spot on the crystal using one or multiple lenses or mirrors, as shown in FIG. 4D. All cases require an opening in the spectrally-selective coating on the crystal, which might also be anti-reflection coated to reduce losses from Fresnel reflections. A small opening in the coating is desirable to reduce losses on subsequent laser passes.

FIG. 4A shows a first example of a pump illumination arrangement for a cooling crystal 400 according to examples the present disclosure. As shown in FIG. 4A, cooling crystal 402, which can be the same as cooling crystal 302, comprises first mirror coating 404, which can be the same as first mirror coating 304, formed on a first end, i.e., facet, of cooling crystal 402 and second mirror coating 406, which can be the same as second mirror coating 306, formed on a second end, i.e., facet, of cooling crystal 402. Laser source, such as laser diode 408, which is cooled by heatsink 410, provides and directs laser beam 412 through second mirror coating 406, such as through an aperture in second mirror coating 406 to be reflected back into cooling crystal 402 by first mirror coating 404.

FIG. 4B shows a second example of a pump illumination arrangement for a cooling crystal 422 according to examples the present disclosure. As shown in FIG. 4B, cooling crystal 402, which can be the same as cooling crystal 302, comprises first mirror coating 404, which can be the same as first mirror coating 304, formed on a first end, i.e., facet, of cooling crystal 402 and second mirror coating 406, which can be the same as second mirror coating 306, formed on a second end, i.e., facet, of cooling crystal 402. Laser source, such as laser diode 408, which is cooled by heatsink 410, provides and directs laser beam 412 through onto lens 414 and second mirror coating 406, such as through an aperture in second mirror coating 406 to be reflected back into cooling crystal 402 by first mirror coating 404.

FIG. 4C shows a third example of a pump illumination arrangement for a cooling crystal 424 according to examples the present disclosure. As shown in FIG. 4C, cooling crystal 402, which can be the same as cooling crystal 302, comprises first mirror coating 404, which can be the same as first mirror coating 304, formed on a first end, i.e., facet, of cooling crystal 402 and second mirror coating 406, which can be the same as second mirror coating 306, formed on a second end, i.e., facet, of cooling crystal 402. Laser source, such as laser diode 408 of FIG. 4A or another laser source, which can be, but may not need to be cooled by heatsink 410 of FIG. 4A depending on the configuration of the laser source, provides and directs laser beam 412 via optical fiber 416 through second mirror coating 406, such as through an aperture in second mirror coating 406 to be reflected back into cooling crystal 402 by first mirror coating 404.

FIG. 4D shows a fourth example of a pump illumination arrangement for a cooling crystal 426 according to examples the present disclosure. As shown in FIG. 4D, cooling crystal 402, which can be the same as cooling crystal 302, comprises first mirror coating 404, which can be the same as first mirror coating 304, formed on a first end, i.e., facet, of cooling crystal 402 and second mirror coating 406, which can be the same as second mirror coating 306, formed on a second end, i.e., facet, of cooling crystal 402. Laser source, such as laser diode 408 of FIG. 4A or another laser source, which can be, but may not need to be cooled by heatsink 410 of FIG. 4A depending on the configuration of the laser source, provides and directs laser beam 412 via optical fiber 416 through first lens 418, second lens 420 and second mirror coating 406, such as through an aperture in second mirror coating 406 to be reflected back into cooling crystal 402 by first mirror coating 404.

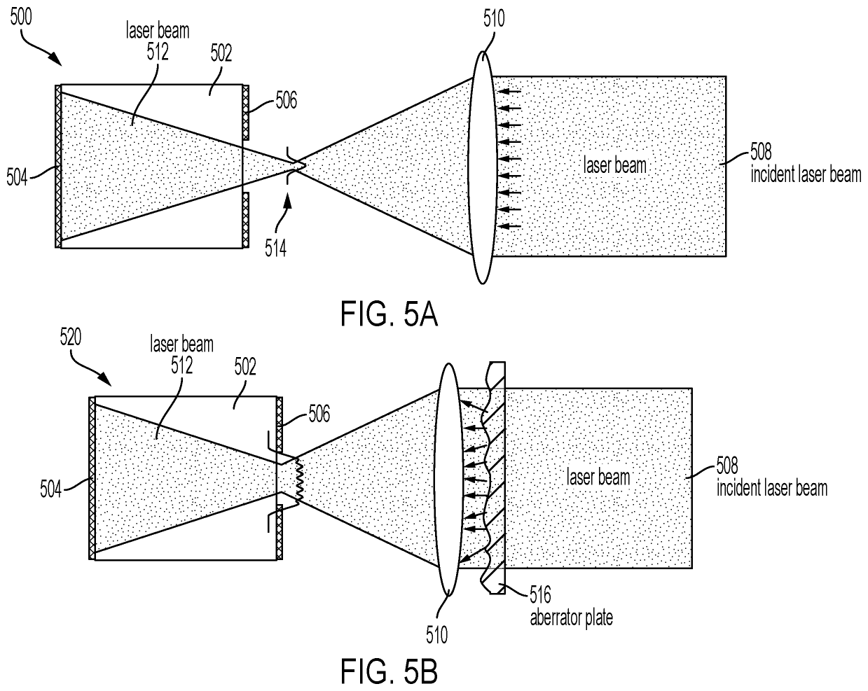

While these schemes are ideal for a free space or fiber-couple laser diode, any other laser source could be used as well. However, the large divergence of a diode laser or fiber is ideal for these applications, as the rapidly expanding beam results in lower and more uniform laser intensity inside the cooling crystal. Especially at high power, this avoids reduced cooling efficiency due to saturation. In addition, utilizing a diode laser, as opposed to a fiber laser, will also increase the energy efficiency of the system. In case a high-brightness laser, like a fiber laser is used, the short focal length lens needed to create sufficiently large divergence results in a very small focal spot of the laser beam and care must be taken to avoid damage to the cooling crystal surface. This could be done by focusing the laser just outside the crystal surface, as shown in FIG. 5A, or by distorting the wavefront of the laser sufficiently to prevent too tight focusing, as shown in FIG. 5B, e.g. by using an aberrator plate. For low-brightness lasers like diode lasers the spot size is typically large enough to avoid any damage.

FIG. 5A shows a first example of an illumination arrangement for a cooling crystal 500 according to examples the present disclosure. As shown in FIG. 5A, cooling crystal 502, which can be the same as cooling crystal 302, comprises first mirror coating 504, which can be the same as first mirror coating 304, formed on a first end, i.e., facet, of cooling crystal 502 and second mirror coating 506, which can be the same as second mirror coating 306, formed on a second end, i.e., facet, of cooling crystal 502. Incident laser beam 508, such as emitted by laser diode 408 of FIG. 4A or another laser source, which can be, but may not need to be cooled by heatsink 410 of FIG. 4A depending on the configuration of the laser source, provides and directs laser beam 512 through lens 510, which focuses laser beam 512 outside of cooling crystal 502 at focal point 514, and second mirror coating 506, such as through an aperture in second mirror coating 506 to be reflected back into cooling crystal 502 by first mirror coating 504.

FIG. 5B shows a second example of an illumination arrangement for a cooling crystal 520 according to examples the present disclosure. As shown in FIG. 5B, cooling crystal 502, which can be the same as cooling crystal 302, comprises first mirror coating 504, which can be the same as first mirror coating 304, formed on a first end, i.e., facet, of cooling crystal 502 and second mirror coating 506, which can be the same as second mirror coating 306, formed on a second end, i.e., facet, of cooling crystal 502. Incident laser beam 508, such as emitted by laser diode 408 of FIG. 4A or another laser source, which can be, but may not need to be cooled by heatsink 410 of FIG. 4A depending on the configuration of the laser source, provides and directs laser beam 512 through aberrator plate 516 and lens 510, which directs laser beam 512 onto second mirror coating 506, such as through an aperture in second mirror coating 506 to be reflected back into cooling crystal 502 by first mirror coating 504.

Unlike shown in previous renditions that use external Herriott cells as pump circulators [3, 4, 7], a heat link cannot be directly attached to the sides of the crystal, as this would reduce or eliminate the refractive index contrast and disrupt the total internal reflection from that facet, resulting in a loss of confinement of part of the laser beam. Instead, according to examples of the present disclosure, a heat link is attached directly to the other side of a mirror coating, typically on the facet opposite the one with the laser input aperture, though any of the sides of the crystal could be coated with an appropriate coating.

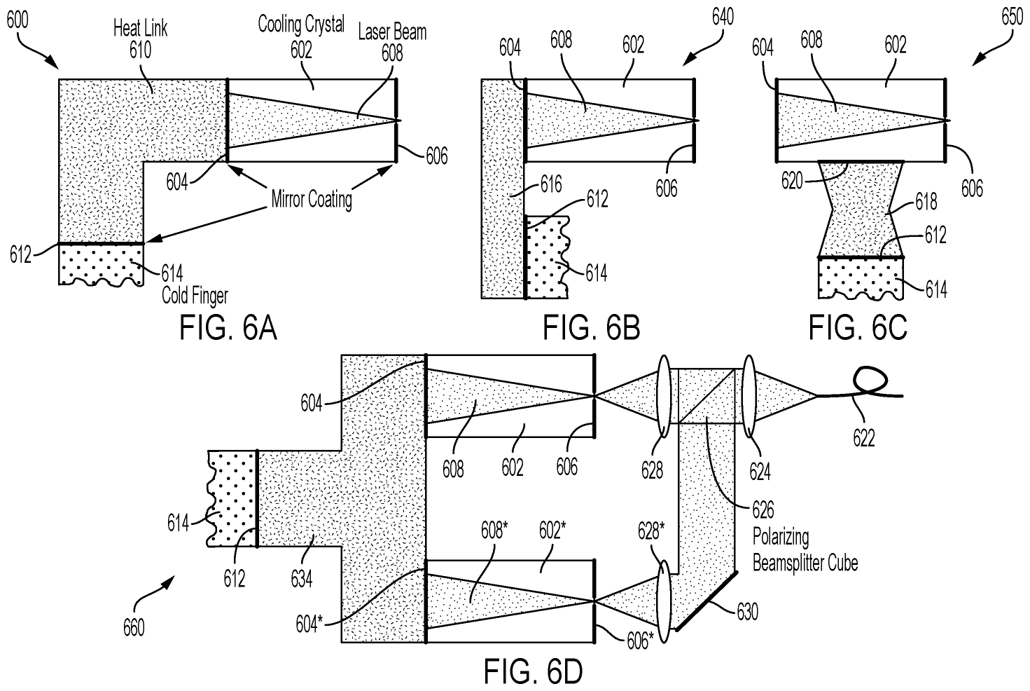

For the heat link geometry, most configurations shown in [7] can be utilized, though some might need minor modifications due to the different attachment point. Also, most of the design consideration from [7] still apply, e.g. matching the coefficient of thermal expansion of the heat link to the cooling crystal, and texturing some of the surfaces of the heat link to avoid total internal reflection inside the heat link. Some possible configurations are shown in FIG. 6A, FIG. 6B, 6C, and FIG. 6D. In cases shown in FIG. 6A and FIG. 6B, the heat link is attached to an existing mirror coating on the crystal. This could either be a selective coating as described in [6], or a broad-band high-reflectivity (BBHR) coating, that reflects both the pump and fluorescence light. In the latter case, using a spectrally selective coating on the opposite crystal faced would still suppress amplified spontaneous emission or lasing in the cooling crystal. Using a BBHR coating between the cooling crystal and heat link would help reduce the amount of fluorescence light entering the link and might allow for a simpler/shorter heat link design, or possibly even a complete elimination of the heat link. For the geometry in FIG. 6C an additional coating on the crystal or heat link surface would be required to maintain laser confinement inside the cooling crystal.

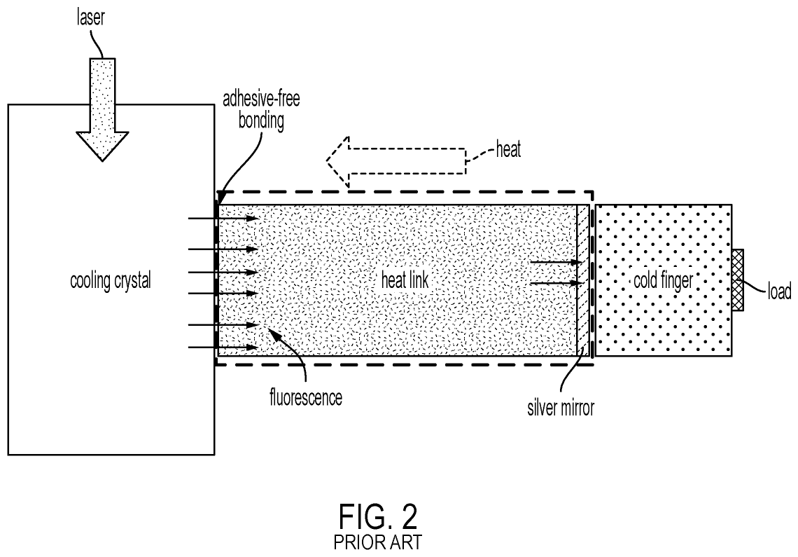

FIG. 6A shows a first example of a cryocooler 600 according to examples the present disclosure. As shown in FIG. 6A, cooling crystal 602, which can be the same as cooling crystal 302, comprises first mirror coating 604, which can be the same as first mirror coating 304, formed on a first end, i.e., facet, of cooling crystal 602 and second mirror coating 606, which can be the same as second mirror coating 306, formed on a second end, i.e., facet, of cooling crystal 602. Laser source (not shown) can be laser diode 408 of FIG. 4A or another laser source, which can be, but may not need to be cooled by heatsink 410 of FIG. 4A depending on the configuration of the laser source, provides and directs laser beam 608 through second mirror coating 606, such as through an aperture in second mirror coating 606 to be reflected back into cooling crystal 602 by first mirror coating 604. One end of heat link 610 is attached to first mirror coating 604 and another end of heat link 610 is attached to cold finger 614 via a heat link-cold finger mirror coating 612. As shown in FIG. 6A, heat link 610 is arranged in a “L”-type shape. However, this is only one example, other shapes of heat link 610 can be used depending on the particular configuration of the device. Cold finger 614 is attached to a load (not shown, but shown in FIG. 2) to be cooled.

FIG. 6B shows a second example of a cryocooler 640 according to examples the present disclosure. As shown in FIG. 6B, cooling crystal 602, which can be the same as cooling crystal 302, comprises first mirror coating 604, which can be the same as first mirror coating 304, formed on a first end, i.e., facet, of cooling crystal 602 and second mirror coating 606, which can be the same as second mirror coating 306, formed on a second end, i.e., facet, of cooling crystal 602. Laser source (not shown) can be laser diode 408 of FIG. 4A or another laser source, which can be, but may not need to be cooled by heatsink 410 of FIG. 4A depending on the configuration of the laser source, provides and directs laser beam 608 through second mirror coating 606, such as through an aperture in second mirror coating 606 to be reflected back into cooling crystal 602 by first mirror coating 604. One portion of heat link 616 is attached to first mirror coating 604 and another portion of heat link 616 is attached to cold finger 614 via a heat link-cold finger mirror coating 612. Heat link 616 can be composed of the same materials as heat link 610. As shown in FIG. 6B, heat link 610 is arranged in a vertical column-type shape where the heat link 616 is attached to cooling crystal 602 and cold finger 614 on the same side of heat link 615. However, this is only one example, other shapes of heat link 616 can be used depending on the particular configuration of the device. Cold finger 614 is attached to a load (not shown, but shown in FIG. 2) to be cooled.

FIG. 6C shows a third example of a cryocooler 650 according to examples the present disclosure. As shown in FIG. 6C, cooling crystal 602, which can be the same as cooling crystal 302, comprises first mirror coating 604, which can be the same as first mirror coating 304, formed on a first end, i.e., facet, of cooling crystal 602 and second mirror coating 606, which can be the same as second mirror coating 306, formed on a second end, i.e., facet, of cooling crystal 602. Laser source (not shown) can be laser diode 408 of FIG. 4A or another laser source, which can be, but may not need to be cooled by heatsink 410 of FIG. 4A depending on the configuration of the laser source, provides and directs laser beam 608 through second mirror coating 606, such as through an aperture in second mirror coating 606 to be reflected back into cooling crystal 602 by first mirror coating 604. One end of heat link 618 is attached to cooling crystal 602 via third mirror coating 620 arranged on a third end, i.e., facet, of cooling crystal 602 and another end of heat link 618 is attached to cold finger 614 via a heat link-cold finger mirror coating 612. As shown in FIG. 6A, heat link 610 is arranged in a vertical column-type shape. However, this is only one example, other shapes of heat link 618 can be used depending on the particular configuration of the device. Cold finger 614 is attached to a load (not shown, but shown in FIG. 2) to be cooled.

FIG. 6D shows a fourth example of a cryocooler 660 according to examples the present disclosure. As shown in FIG. 6D, two cooling crystals are used, namely cooling crystal 602, 602*, which can be the same as cooling crystal 302. Each cooling crystal 602, 602* comprises first mirror coating 604, 604* which can be the same as first mirror coating 304, formed on a first end, i.e., facet, of cooling crystal 602, 602* and second mirror coating 606, 606* which can be the same as second mirror coating 306, formed on a second end, i.e., facet, of cooling crystal 602, 602*. Laser source (not shown) can be laser diode 408 of FIG. 4A or another laser source, which can be, but may not need to be cooled by heatsink 410 of FIG. 4A depending on the configuration of the laser source, provides and directs laser beam 608, 608* through fiber 622 and first lens 624. Laser beam 608, 608* are split by beamsplitter, such as polarizing beamsplitter cube 626. Laser beam 608 passes through the beamsplitter on through second lens 628, which focuses laser beam 608 onto second mirror coating 606, such as through an aperture in second mirror coating 606 to be reflected back into cooling crystal 602 by first mirror coating 604. Laser beam 608* is reflected by the beamsplitter on is directed onto mirror 630 and through third lens 628*, which focuses laser beam 608* onto second mirror coating 606*, such as through an aperture in second mirror coating 606* to be reflected back into cooling crystal 602* by first mirror coating 604*. One portion of heat link 634 is attached to cooling crystal 602 via first mirror coating 604 of cooling crystal 602 and another portion of heat link 634 is attached to cooling crystal 602* via first mirror coating 604* of cooling crystal 602*. Another portion of heat link 634 is attached to cold finger 614 via a heat link-cold finger mirror coating 612. As shown in FIG. 6D, heat link 634 is arranged in a “T”-type shape where cooling crystal 602, 602*, and cold finger 614 are each attached to the ends of the “T”-type shape. However, this is only one example, other shapes of heat link 634 can be used depending on the particular configuration of the device. Cold finger 614 is attached to a load (not shown, but shown in FIG. 2) to be cooled.

In all above implementations, an additional mirror coating could be applied to the end of the heat link in contact with the cold finger, or to the cold finger itself, to reduce the amount of light being absorbed by the cold finger (as in [3] and [7]). Since the amount of light reaching this interface can be very low (depending on the heat link design), this could be a lower-reflectivity coating, e.g. metallic mirror, or dielectric/semiconductor mirror with fewer layers to optimize thermal conductivity.

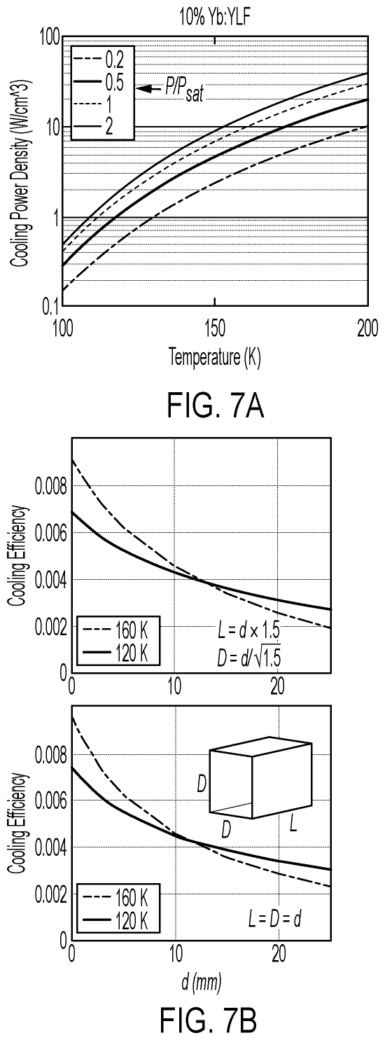

Increasing the cooling power in optical refrigeration cannot indefinitely be achieved by increasing the laser power, as absorption saturation reduces cooling efficiency at higher intensities, as can be seen in FIG. 7A. Note that there is only a small increase in cooling power for a given temperature, once the laser power P is at or above the saturation power Pₛₐₜ. FIG. 7A shows cooling power density, so one would naively expect to increase the cooling power by increasing the crystal size. Unfortunately, as shown in FIG. 7B, the cooling efficiency drops for larger crystal size, due to reabsorption of the emitted fluorescence as it leaves the crystal. Therefore, to achieve very high cooling powers, it is beneficial to connect multiple cooling crystals (with optimal dimensions; e.g. d˜7 mm for 10% doped Yb:YLF) to the same heat link, as shown in FIG. 6D. While the depicted heat link is larger than in the other configurations, this does not necessarily have to be the case, especially when using a 3-dimensional heat link design, optimized for low fluorescence transmission with high thermal conductivity [7]. It is feasible to use 2 or more cooling crystals without an increase in heat link size, as to not increase the system thermal mass, thermal resistivity, and radiative heat load. Another reason for using multiple cooling crystals might be to utilize an unpolarized pump laser. Since the cooling efficiency in optical refrigeration of most crystals is dependent on the polarization, an unpolarized source could be split into two orthogonal polarizations and each cooling crystal could be oriented for optimal cooling.

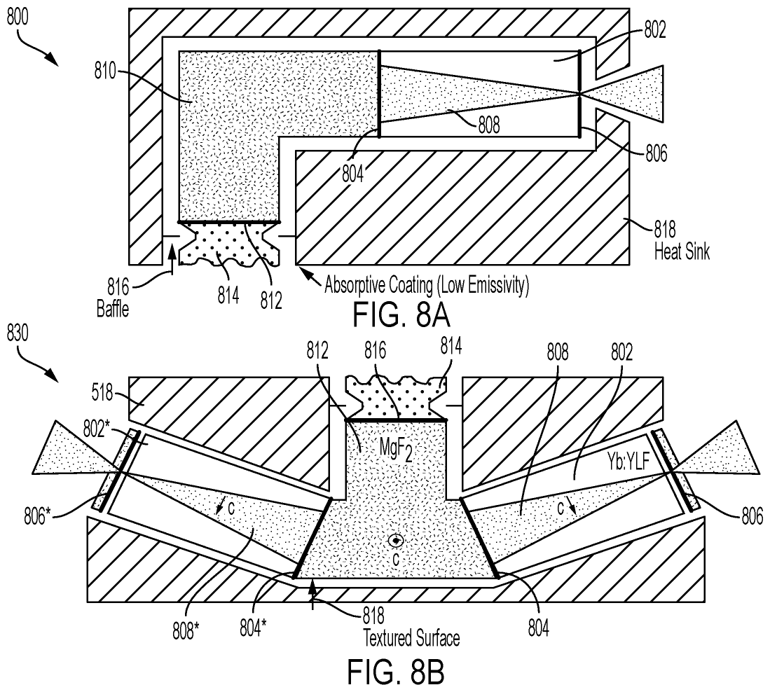

To complete the cryocooler design as shown in FIG. 8A and FIG. 8B, the cooling crystal and heat link assembly should be tightly surrounded by an absorptive coating for the crystal fluorescence, which also has low emissivity at thermal wavelengths, to reduce the radiative heatload on the system. The geometry of the coating, possibly in combination with one or multiple baffles also ensures that no fluorescence reaches the cold finger or load to be cooled. The coating should be applied to a heat sink, to remove excess heat from the system. The whole assembly would be housed inside a vacuum chamber, to reduce the convective heatload and avoid condensation of water on cold surfaces. The laser source could either be placed inside the vacuum system, or fed in through a fiber feedthrough or optical window. The design in FIG. 8B shows material choices and crystal alignment for a Yb:YLF based cryocooler, but the principles disclosed here apply to any laser cooling system, independent of host (crystal, glass, ceramic, . . . ) and cooling material (Yb, Tm, Ho, Er, . . . ).

FIG. 8A shows one example of a cryocooler 800 according to examples the present disclosure. As shown in FIG. 8A, cooling crystal 802, which can be the same as cooling crystal 302, comprises first mirror coating 804, which can be the same as first mirror coating 304, formed on a first end, i.e., facet, of cooling crystal 802 and second mirror coating 806, which can be the same as second mirror coating 306, formed on a second end, i.e., facet, of cooling crystal 802. Laser source (not shown) can be laser diode 408 of FIG. 4A or another laser source, which can be, but may not need to be cooled by heatsink 410 of FIG. 4A depending on the configuration of the laser source, provides and directs laser beam 808 through second mirror coating 806, such as through an aperture in second mirror coating 806 to be reflected back into cooling crystal 802 by first mirror coating 804. One end of heat link 810, which can be the same as heat link 610, is attached to first mirror coating 804 and another end of heat link 810 is attached to cold finger 814 via a heat link-cold finger mirror coating 812. As shown in FIG. 8A, heat link 810 is arranged in a “L”-type shape. However, this is only one example, other shapes of heat link 810 can be used depending on the particular configuration of the device. Baffle 816 is arranged near the junction of cold finger 814 and heat link-cold finger mirror coating 812 and provides for extra shielding so that little if any fluorescence reaches cold finger 814 or load to be cooled. Heat sink 818 can surround portions, if not all, the above device components.

FIG. 8A shows another example of a cryocooler 830 according to examples the present disclosure. As shown in FIG. 8B, two cooling crystals are used, namely cooling crystal 802, 802*, which can be the same as cooling crystal 302. Each cooling crystal 802, 802* comprises first mirror coating 804, 804* which can be the same as first mirror coating 304, formed on a first end, i.e., facet, of cooling crystal 802, 802* and second mirror coating 806, 806* which can be the same as second mirror coating 306, formed on a second end, i.e., facet, of cooling crystal 802, 802*. Two laser sources (not shown) are used and each can be the same as laser diode 408 of FIG. 4A or another laser source, which can be, but may not need to be cooled by heatsink 410 of FIG. 4A depending on the configuration of the laser source, provides and each laser source directs respective laser beam 608, 608* onto second mirror coating 806, 806*, respectively, such as through an aperture in second mirror coating 806, 806* to be reflected back into cooling crystal 802, 802* by first mirror coating 604, 604*, respectively. One portion of heat link 812 is attached to cooling crystal 802 via first mirror coating 804 of cooling crystal 802 and another portion of heat link 812 is attached to cooling crystal 802* via first mirror coating 804* of cooling crystal 802*. Another portion of heat link 812 is attached to cold finger 814 via a heat link-cold finger mirror coating 816. As shown in FIG. 6D, heat link 634 is arranged in a generally three-sided-type shape where cooling crystal 802, 802*, and cold finger 814 are each attached to different sides of the three-sided shape. However, this is only one example, other shapes of heat link 812 can be used depending on the particular configuration of the device.

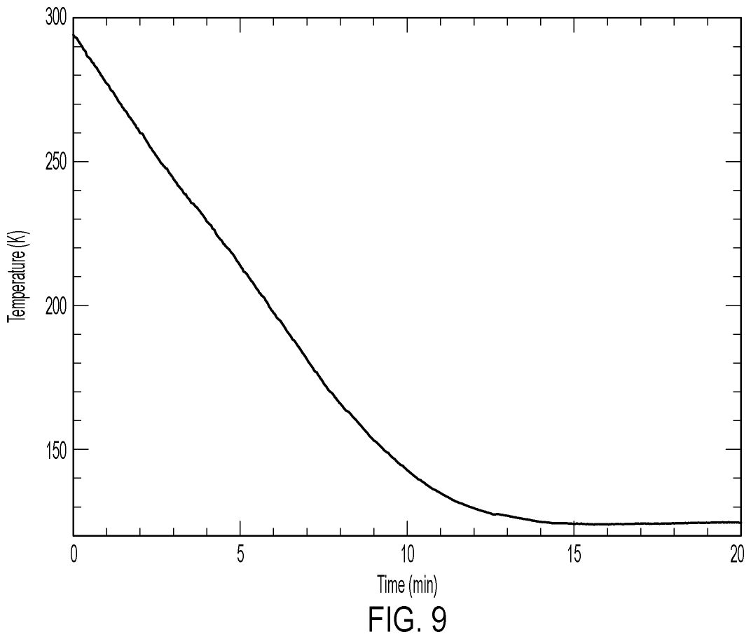

We have coupled 40 W of linearly polarized light from a 1020 nm fiber-coupled laser diode module into a 10% Yb:YLF crystal with spectrally-selective mirror coatings on two facets in a setup as shown in FIG. 4d. The crystal was housed in a vacuum chamber and supported by silica aerogel to reduce thermal conductivity. Crystal temperature as function of time after turning on the laser power is shown in FIG. 9, with the crystal reaching a minimum temperature of 124 K after approximately 16 minutes. Note that in this experiment the crystal was not surrounded by an absorptive, low emissivity coating to reduce thermal load and no measures were taken to cool the vacuum chamber exposed to the fluorescence generated, causing it to heat up. This resulted in a higher crystal temperature than could be achieved in an optimized setup, as well as a slow rise of the crystal temperature after achieving the minimum.

### BACKGROUND REFERENCES

[1] Denis V. Seletskiy, Richard Epstein, Markus P. Hehlen, Mansoor Sheik-Bahae, “Solid state optical refrigeration using stark manifold resonances in crystals,” U.S. Pat. No. 9,574,801, 2017.
[2] A. Volpi et al., “Optical refrigeration: the role of parasitic absorption at cryogenic temperatures,” Opt. Express, vol. 27, no. 21, p. 29710, October 2019.
[3] M. P. Hehlen et al., “First demonstration of an all-solid-state optical cryocooler,” Light Sci. Appl., vol. 7, no. 1, 2018.
[4] J. Kock, J. Meng, A. Volpi, A. R. Albrecht, R. I. Epstein, and M. Sheik-Bahae, “Advances in optical cryo-cooler device development (Conference Presentation),” in Photonic Heat Engines: Science and Applications II, 2020, vol. 11298, p. 8.
[5] A. Gragossian, J. Meng, M. Ghasemkhani, A. R. Albrecht, and M. Sheik-Bahae, “Astigmatic Herriott cell for optical refrigeration,” Opt. Eng., vol. 56, no. 1, p. 011110, 2016.
[6] Jackson Kock, Azzurra Volpi, Alexander R. Albrecht, Mansoor Sheik-Bahae, “Methods for Spectrally-Selective Laser Circulator for Cryogenic Optical Refrigeration”, UNMRI Ref No. 2021-075-01.
[7] Mansoor Sheik-Bahae, Alexander Robert Albrecht, Junwei Meng, “CTE-matched textured heatlinks for optical refrigeration”, U.S. Pat. No. 11,088,506, Aug. 10, 2021.

While the embodiments have been illustrated respect to one or more implementations, alterations and/or modifications can be made to the illustrated examples without departing from the spirit and scope of the appended claims. In addition, while a particular feature of the embodiments may have been disclosed with respect to only one of several implementations, such feature may be combined with one or more other features of the other implementations as may be desired and advantageous for any given or particular function.

Furthermore, to the extent that the terms “including”, “includes”, “having”, “has”, “with”, or variants thereof are used in either the detailed description and the claims, such terms are intended to be inclusive in a manner similar to the term “comprising.” As used herein, the phrase “one or more of”, for example, A, B, and C means any of the following: either A, B, or C alone; or combinations of two, such as A and B, B and C, and A and C; or combinations of three A, B and C.

Other embodiments will be apparent to those skilled in the art from consideration of the specification and practice of the descriptions disclosed herein. It is intended that the specification and examples be considered as exemplary only, with a true scope and spirit of the embodiments being indicated by the following claims.

What is claimed is:

1. A laser cooling system comprising:
a multi-pass optical cavity;
a first mirrored crystal;
a first mirror comprising a hole that allows a pump laser beam to enter, wherein the first mirror is positioned at a first end of the first mirrored crystal;
a second mirror positioned at a second end of the first mirrored crystal; and
a laser source that produces a divergent laser beam or that produces a laser beam that is made divergent using one or more optical elements that is coupled into the first mirrored crystal,
wherein the laser beam is reflected within the first mirrored crystal between the first mirror and the second mirror by total internal reflection.

2. The laser cooling system of claim 1, wherein the first mirror or the second mirror comprises a spectrally selective coating to suppress amplified spontaneous emission (ASE) and parasitic lasing to avoid undesired heat generation in a material being cooled in the multi-pass optical cavity and the spectrally selective coating is deposited onto the mirrored crystal such that a stable laser resonator is not formed.

3. The laser cooling system of claim 2, wherein the spectrally selective coating of the first mirror comprises a long-pass mirror coating the spectrally selective coating of the second mirror comprises a short-pass mirror coating.

4. The laser cooling system of claim 1, wherein one or more optical elements comprise one or more lenses or one or more aberrator plates.

5. The laser cooling system of claim 1, wherein at least one facet of the first mirrored crystal is polished at an angle or at a specific curvature.

6. The laser cooling system of claim 1, wherein at least one facet of the first mirrored crystal is uncoated or coated with an anti-reflection coating.

7. The laser cooling system of claim 1, wherein the first mirror or the second mirror comprises a flat, curved, or angled reflective surface and is arranged externally and in close proximity to the first mirrored crystal.

8. The laser cooling system of claim 1, further comprising a spectrally selective filter element that is arranged in the multi-pass cavity.

9. The laser cooling system of claim 1, wherein the divergent laser beam is focused to a point or a line on the first surface of mirrored crystal using one or more lenses or mirrors.

10. The laser cooling system of claim 1, further comprising a heat link that is coupled to the multi-pass cavity at one end and coupled to a cold finger at another end.

11. The laser cooling system of claim 1, wherein the first mirrored crystal comprises a rare-earth-doped crystal.

12. The laser cooling system of claim 1, wherein the spectrally selective coating introduces a loss at wavelengths longer than a pump laser and prevents buildup of ASE and eliminates laser oscillation at longer wavelengths by ensuring a net optical gain that never exceeds losses in each roundtrip in the multi-pass optical cavity.

13. The laser cooling system of claim 1, wherein the first mirror, the second mirror, or both the first mirror and the second mirror have low reflectivity for longer wavelengths of a fluorescence spectrum.

14. The laser cooling system of claim 1, wherein the spectrally selective coating comprises a dielectric coating or a distributed Bragg reflector that is deposited on a surface of the first mirror or the second mirror or attached to the mirrored crystal.

15. The laser cooling system of claim 1, comprising an optical fiber that couples the laser source to the first mirrored crystal.

16. A method for laser cooling, the method comprising:
directing a divergent laser beam into a multi-pass optical cavity, the multi-pass cavity comprising a first mirror positioned at a first end of the multi-pass optical cavity and a second mirror positioned at a second end of the multi-pass optical cavity, wherein the first mirror or the second mirror comprises a spectrally selective coating to suppress amplified spontaneous emission (ASE) and parasitic lasing to avoid undesired heat generation in a material being cooled in the multi-pass optical cavity and the spectrally selective coating is deposited onto the crystal such that a stable laser resonator is not formed; and
optically cooling the material by repeated passes of the pump laser beam.

17. The method of claim 16, wherein the material being cooled comprises a rare-earth-doped crystal.

18. The method of claim 16, wherein the spectrally selective coating introduces a loss at wavelengths longer than a pump laser and prevents buildup of ASE while eliminating laser oscillation at longer wavelengths by ensuring a net optical gain that never exceeds losses in each roundtrip in the multi-pass optical cavity.

19. A laser cooling system comprising:
a multi-pass optical cavity;
a first crystal;
a first mirror positioned at a first end of the first crystal;
a second mirror positioned at a second end of the first crystal;
a second crystal;
a third mirror positioned at a first end of the second crystal;
a fourth mirror positioned at a second end of the second crystal;
a heat link that couples the first crystal and the second crystal;
a first laser source that produces a first divergent laser beam that is coupled into the first crystal; and
a second laser source that produces a second divergent laser beam that is coupled into the second crystal,
wherein the first mirror or the second mirror and the third mirror or the fourth mirror comprise a spectrally selective coating to suppress amplified spontaneous emission (ASE) and parasitic lasing to avoid undesired heat generation in a material being cooled in the multi-pass optical cavity and the spectrally selective coating is deposited onto the crystal.

20. The laser cooling system of claim 19, wherein the heat link comprises a MgF₂ heat link with a textured surface to reduce total internal reflection inside the heat link.
